(19) United States
(12) Patent Application Publication
(10) Pub. No.: US 2014/0286217 A1
(43) Pub. Date: Sep. 25, 2014

(54) POWER MANAGEMENT IN A WIRELESS NETWORK HAVING STATIONS WITH DIFFERENT POWER CAPABILITIES

(71) Applicants: Minyoung PARK, Portland, OR (US); Emily Qi, Portland, OR (US)

(72) Inventors: Minyoung PARK, Portland, OR (US); Emily Qi, Portland, OR (US)

(21) Appl. No.: 14/219,526

(22) Filed: Mar. 19, 2014

Related U.S. Application Data
(63) Continuation of application No. 13/074,464, filed on Mar. 29, 2011.
(60) Provisional application No. 61/421,966, filed on Dec. 10, 2010.

(51) Int. Cl. H04W 52/02

(52) U.S. Cl. CPC H04W 52/0216
USPC 370/311

(57) ABSTRACT

Embodiments herein provide a device for communicating in a wireless network, the device comprising a processor, a memory, and a radio, wherein the device is to communicate to an associated access point (AP) information that includes a Max Idle time period corresponding to a time period set within the AP during which the device may be in a power save mode without being disconnected from the AP and wherein in the power save mode, the device is to selectively transmit to the associated AP and selectively refrain from transmission to the associated AP.

### CROSS-REFERENCE TO RELATED APPLICATIONS

This application is a continuation application of Ser. No. 13/074,464 filed Mar. 29, 2011, entitled “POWER MANAGEMENT IN A WIRELESS NETWORK HAVING STATIONS WITH DIFFERENT POWER CAPABILITIES”, which claims benefit from provisional application of Ser. No. 61/421,966 filed Dec. 10, 2010, entitled “METHODS AND TECHNIQUES FOR A NOVEL LOW POWER WIFI DEVICE AND SYSTEM”.

### BACKGROUND

Within a wireless network, some wireless stations (STAs) may include high performing stations (STAs) such as laptops, etc, which are not as constrained by battery life, and smaller typically battery powered STAs such as for example sensors, which need to last many years with small battery capacity. Currently, if an access point (AP) does not receive a packet from an associated STA within a fixed period of time (i.e. a keep-alive time period in Wi-Fi, it disconnects the STA from the wireless network, since it will assume that the station is busy. The above is true whether the STA is a high performing station, such as one powered by a large high capacity Lithium-Ion battery, or whether the STA is powered by a low capacity battery, such as, for example, a regular AA type battery. If the keep-alive time period, which is typically set by an IT administrator, is relatively short, the associated STAs would need to wake up before the keep-alive time period expires, and send a packet to maintain the association with that AP, even though they may not have any packets to send. Sending a packet merely for the purpose of maintaining associated can be costly to a STA in terms of power consumption, especially in the case of the smaller battery powered STAs.

### BRIEF DESCRIPTION OF THE DRAWINGS

Some embodiments of the invention may be better understood by referring to the following description and accompanying drawings that are used to illustrate embodiments of the invention. In the drawings:

FIG. 1a is a schematic diagram of a wireless communications network, according to an embodiment.

FIG. 1b is a schematic diagram of a STA and of an AP according to an embodiment;

FIG. 2 is a schematic depiction of a BSS Low Power Capability element (LPC element) according to an embodiment.

FIG. 3 is a flow-chart of a method of power saving in wireless network in accordance with an embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a computer-readable medium, which may be read and executed by one or more processors to enable performance of the operations described herein. A computer-readable medium may include any mechanism for storing information in a form readable by one or more computers. For example, a computer-readable medium may include a tangible storage medium, such as but not limited to read only memory (ROM); random access memory (RAM); magnetic disk storage media; optical storage media; a flash memory device, etc.

The term “wireless” may be used to describe circuits, devices, systems, methods, techniques, communications channels, etc., that communicate data by using modulated electromagnetic radiation through a non-solid medium. The term does not imply that the associated devices do not contain any wires. A wireless device may comprise at least one antenna, at least one radio, at least one memory, and at least one processor, where the radio transmits signals through the antenna that represent data and receives signals through the antenna that represent data, while the processor may process the data to be transmitted and the data that has been received. The processor may also process other data which is neither transmitted nor received.

A “STA” may be embodied as a communication station, a mobile station, an advanced station, a client; a platform, a wireless communication device, a wireless AP, a modem, a wireless modem, a Personal Computer (PC), a desktop computer, a mobile computer, a laptop computer, a notebook computer, a tablet computer, a server computer, a set-top box, a handheld computer, a handheld device, a Personal Digital Assistant (PDA) device, a handheld PDA device, and/or a netbook.

Alternately or in combination, the STAs or platforms can also use signals to communicate in a wireless network such as a Local Area Network (LAN), a Wireless LAN (WLAN), a Metropolitan Area Network (MAN), a Wireless MAN (WMAN), a Wide Area Network (WAN), a Wireless WAN (WWAN), devices and/or networks operating in accordance with existing Next Generation mmWave (NGmS-D02/r0, Nov. 28, 2008), Wireless Gigabit Alliance (WGA), IEEE 802.11, 802.11a, 802.11b, 802.11e, 802.11g, 802.11 h, 802.11i, 802.11n, 802.11ac, 802.16, 802.16d, 802.16e standards and/or future versions and/or derivatives and/or Long Term Evolution (LTE) of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Maximum Ratio Combining (MRC) transceiver or device, a transceiver or device having “smart antenna” technology or multiple antenna technology, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), OFDMA, Time-Division Multiplexing (TOM), Time-Division Multiple Access (TDMA), Extended TDMA (E-TDMA), General Packet Radio Service (GPRS), Extended GPRS, Code-Division Multiple Access (CDMA), Wideband CDMA (WCDMA), COMA 2000, Multi-Carrier Modulation (MDM), Discrete Multi-Tone (DMT), Bluetooth®, ZigBee™, or the like. Embodiments may be used in various other apparatuses, devices, systems and/or networks.

In one embodiment, STAs or platforms in a wireless network may operate in accordance with one or more of the IEEE 802.11 standards and/or protocol under development by associated task groups such as 802.11 ac. A STA operating in accordance with these protocols and/or standards may require the implementation of at least two layers. One layer is the 802.11 MAC layer (i.e., OSI Data/Link Layer 2). Another layer is the 802.11 PHY layer (i.e., OSI Physical Layer 1). The MAC layer may be implemented using either or a combination of dedicated hardware and dedicated software. The PHY layer may be implemented using dedicated hardware or through software emulation.

According to some embodiments, information regarding the power capabilities of a wireless device or STA may be communicated to a wireless access point. For example, the wireless device itself may transmit such information to a wireless AR and the information may include a Max Idle Time period (transmitted as a parameter BSSMaxIdlePeriod) corresponding to a time period during which the device is to operate in a power save mode. In a power save mode, the STA can refrain from transmitting frames to the associated AP without being disassociated.

The device may communicate the information within an association or re-association frame to the AP with which the device is seeking association or re-association. The information may be communicated as a parameter in a BSS Low Power Capability element, which may comprise a Low Power Info field including subfields selected from a group consisting of a time period during which the device is to operate in a power save mode, the power source for the device (whether battery or line-power), the device's battery capacity, etc. The AP may receive the information and set a keep-alive time period for the device based on this information. By “keep-alive time period,” what is meant in the instant description is a time period set within the AP during which a STA associated with the AP may be in a power save mode without being disconnected from the AP. After the “keep-alive time period” if the STA is still in a power save mode, the AP will disconnect the STA. When an AP receives the information regarding the power capabilities of a particular STA, the AP may set the keep-alive time period to be equal to or greater than the Max Idle period. The AP may further communicate the keep-alive time period to the device, for example in an association or re-association response frame as a BSS Max-Idle period element. In this way, the AP may apply different sets of parameters, such as different keep-alive time periods, to different classes of stations; based for example on the stations' power capabilities, thus allowing stations operating on smaller batteries to enjoy longer battery lives.

In various embodiments, a STA in a wireless network may have at least two power modes, designated herein as an active mode, in which the device is awake, and a power save mode during which the STA is placed in a non-operational low-power condition. When the STA is in the active mode, the STA is fully functional and can always transmit and receive. In the power save mode, the STA can be either in an awake state or in a doze state. When the STA is in the awake state, the STA can still transmit and receive. When the STA is in the doze state, the STA goes to sleep to reduce power consumption and cannot transmit/receive.

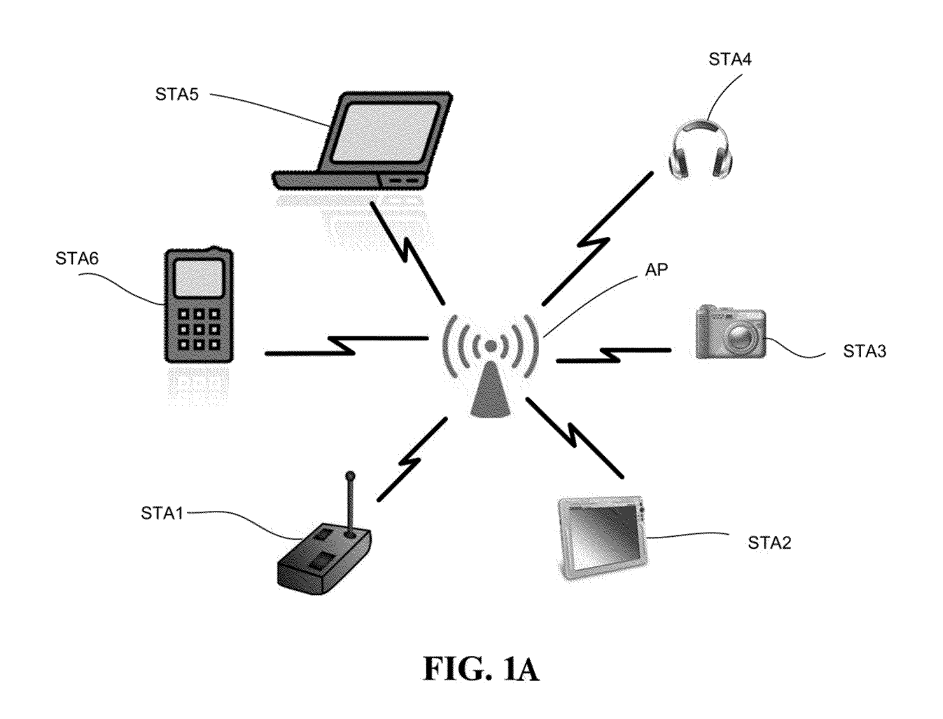

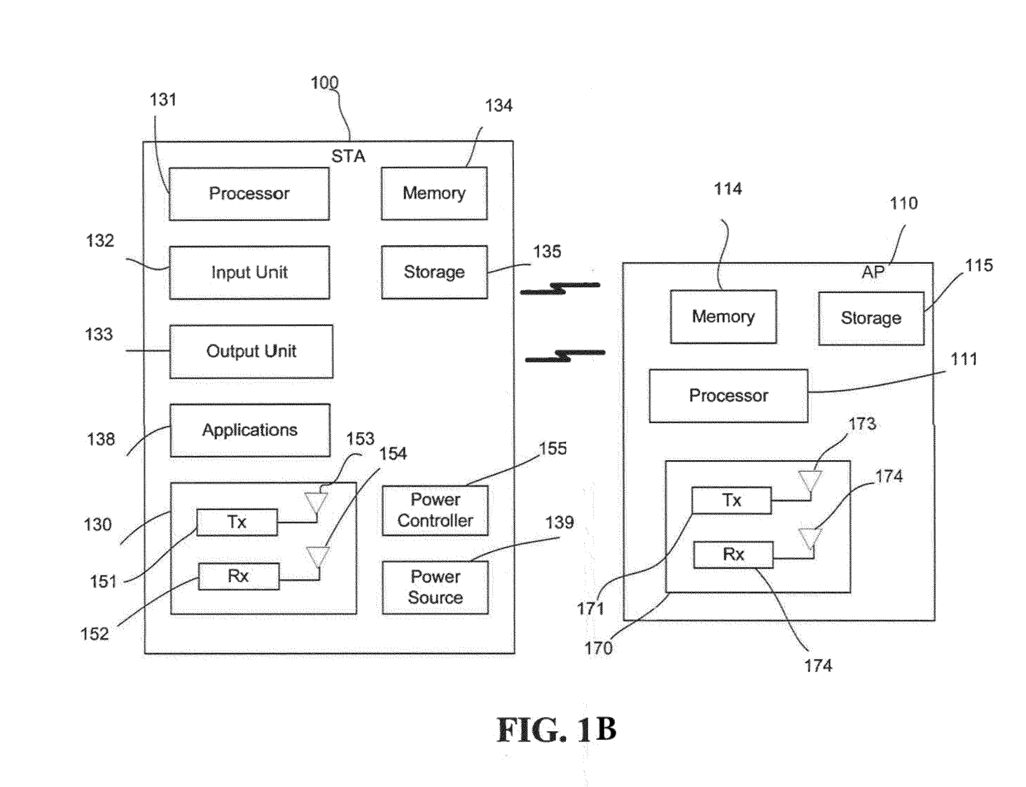

FIG. 1a shows devices in a wireless communications network according to an embodiment. Each device may be assumed to contain at least one processor and at least one radio to facilitate wireless communications. The illustrated embodiment shows an AP as various other devices as the stations (STA1-STA6) the communications for which are largely controlled by the AP. Although specific types of devices are shown (e.g. STA1 as a sensor, STA2 as a display, STA3 as a camera, STA4 as a set of headphone, STA5 as a laptop computer, and STA6 as a smartphone) these are used only as examples of typical wireless devices that may operate on smaller batteries (STA1-STA4) or on larger batteries such as lithium-ion batteries (STA5 and STA6), although operations described herein might also be used on devices that plug into external power sources as an energy saving measure. For example, the use of embodiments for plugged-in devices could advantageously reduce re-association times as well as power consumption, since the re-association could take a relatively long time and increase latency.

Referring next to FIG. 1 b, a STA 100, such as any of the STAs of FIG. 1a, may include, for example, a processor 131, an input unit 132, an output unit 133, a memory unit 134, a storage unit 135, a communication unit 150, a power controller 155, and a power source 139, which may comprise a battery. STA 100 may optionally include other suitable hardware or software components. Input Unit 132 includes, for example, a keyboard, a keypad, a mouse, a touch-pad, a track-ball, a stylus, a microphone, or other suitable pointing device or input device. Output unit 133 includes, for example, a monitor, a screen, a Cathode Ray Tube (CRT) display unit, a Liquid Crystal Display (LCD) display unit, a plasma display unit, one or more audio speakers or earphones, or other suitable output devices. Memory unit 134 may store data processed by STA 100. Communication unit 150 includes, for example, a wireless transceiver, a wireless modem, a wireless Network Interface Card (NIC), or the like. For example, communication unit 150 includes a transmitter 151 and a receiver 152. Transmitter 151 includes, for example, a wireless Radio Frequency (RF) transmitter able to transmit wireless RF signals, blocks, frames, transmission streams, packets, messages and/or data, e.g., through an antenna 153. Receiver 152 includes, for example, a wireless Radio Frequency (RF) receiver able to receive wireless RF signals, blocks, frames, transmission streams, packets, messages and/or data, e.g., through an antenna 154. Optionally, transmitter 151 and receiver 152 may be implemented using a transceiver, a transmitter-receiver, or other suitable components. Optionally, antenna 153 and antenna 154 may be implemented using a common antenna, a common set of multiple antennas, or other suitable component(s). For example, antenna 153 and/or antenna 154 may include an internal and/or external RF antenna, a dipole antenna, a monopole antenna, an omni-directional antenna, an end fed antenna, a circularly polarized antenna, a micro-strip antenna, a diversity antenna, or other type of antenna suitable for transmitting and/or receiving wireless communication signals, blocks, frames, transmission streams, packets, messages and/or data. Power source 139 includes, for example, one or more batteries, rechargeable batteries, non-rechargeable batteries, replaceable batteries, disposable or non-replaceable batteries, internal batteries, external batteries, or other power cells able to provide electric power to one or more components of STA 100.

Optionally, a power controller 155 is able to modify operational properties of STA 100 (or components thereof) based on power-related algorithms or criteria. For example, power controller 155 is able to turn off, turn on, enable, disable, connect and/or disconnect one or more components of STA 100 and is able to command STA 100 or components thereof to go into a power-saving mode.

AP 110 may be or may include, for example, a processor 111, a memory unit 114, a storage unit 115, and a communication unit 170. The communication unit 170 may include, for example, a transmitter 171 associated with an antenna 173, and a receiver 172 associated with an antenna 174. Like devices as between AP 110 and STA 100 may be similar in properties or functionality as described above with respect to components of STA 100.

In some embodiments, some or all of the components of STA 100 and/or of AP 110 may be enclosed in a common housing, packaging, or, the like, and may be interconnected or operably associated using one or more wired or wireless links. In other embodiments, components of STA 100 and/or of AP 110 may be distributed among multiple or separate devices or locations.

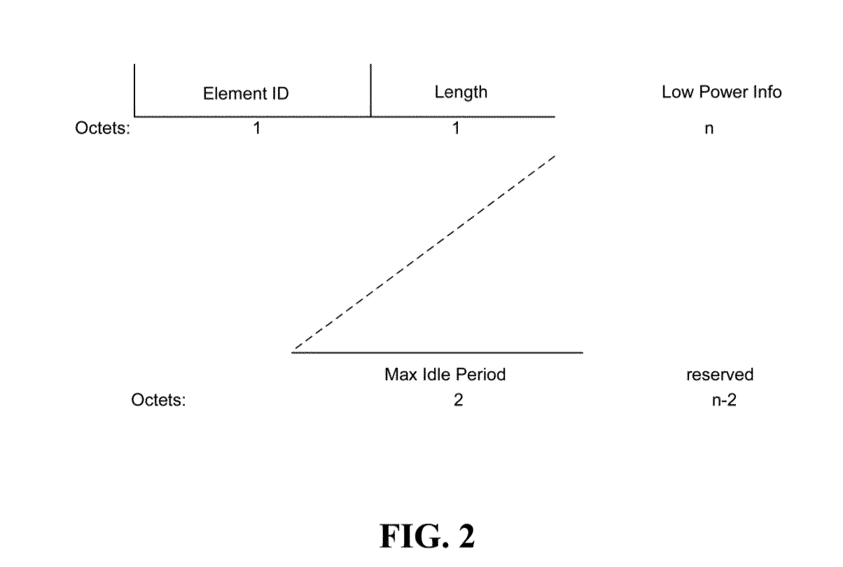

Referring now to FIG. 2, a schematic depiction of a BSS Low Power Capability (LPC) element is shown. The LPC element according to some embodiments may be used to convey information of a STA regarding its power capabilities, such as information selected from a group consisting of a time period during which the STA is to operate in a power save mode, the power source for the STA (whether battery or line-power), the STA's battery capacity, etc. Thus, by “power capabilities,” what is meant is a set of capabilities related to a device's need to consume power and ability to conserve power. An “element” as used herein refers to a portion of a BSS communication frame, that is, a portion of a block of communication protocol within a BSS. The illustrated embodiment of a LPC element suggests specific fields devoted to specific purposes occuning within discrete time periods. Other embodiments may use more, fewer or different time periods with different fields and/or purposes. In the embodiment shown, the first field corresponds to an Element ID field, which may comprise a fixed value identified in the LPC element following the Element ID field may be a Length field, which conveys information regarding the length of the field that follows, that is, the length of the Low Power Info field. The Low Power Info field in turn may include subfields representing information regarding a STA's power capabilities as noted above. Thus, the subfields may be selected from a group consisting of: at time period during which a STA is to operate in a power save mode (Max Idle period for the STA), the power source for the STA (whether battery or line-power), the STA's battery capacity, etc. The Max idle period may be expressed in various ways, such as but not limited to: 1) the number of units of time, with the duration of each unit of time (e.g.: a microsecond) being predetermined and understood by both the STA and AP, or indicated in the LPC element; 2) the start time for the time period and the end time for the time period; etc.

If the Max Idle period subfield is present in the Low Power Info field of the LPC element, the STA is asking the AP to set the keep-alive time period allocated to that STA based on the Max Idle period. The AP may then set the keep-alive time period to be equal to or greater than the Max Idle period, the result being that the particular STA that sent the LPC element can remain in the power save mode for a period of time that is not fixed as set by the AP administrator, but that is determined by the power capabilities and requirements of that particular STA. As a result, the STA can remain in the power save mode for a longer period of time, thus resulting in a longer battery life for the STA as compared with a situation where the keep-alive time period is fixed within the AP. If the AP can support a Max Idle time period in the LPC element in the association or re-association frame as noted above, the AP may then set an equal or greater value for the keep-alive time period in the BSS Max-Idle period element in the association or re-association response frame. In that case, a power controller of the STA, similar for example to STA 100 of FIG. 1b including power controller 155, may be adapted to control the power states of the STA based on the BSS Max-Idle period element in the association or re-association response frame received from the AP. For an AP that does not support the Max Idle time period in the LPC element, the AP may for example send the Max Idle period it can support to the STA. It is then up to the STA to decide what to do next. If the STA really needs a longer Max Idle period than that can be supported by the AP, it may try to find another AP that can support the required longer Max Idle period. The STA may also just associate to the original AP and follow the shorter Max Idle period which the AP sent in the response frame, knowing that the STA will not have the expected battery life. In addition, should the STA move to a new AP while in a power save mode, if the original AP that sent the BSS Max Idle period and the new AP are both managed by a common controller, then the BSS Max Idle period for the STA may be stored across AP's managed by the controller. In such a case, if the STA moves, it may not need to re-associate with the AP and still maintain the Max idle period.

An AP according to an embodiment is not limited to one which will either set a keep-alive time period based on power capability information, or will impose its own predetermined keep-alive time period. Thus, an AP according to an embodiment may be adapted to accommodate both a STA that cannot and a STA that can transmit information regarding its power capabilities. In this way, a wireless network may be able to advantageously accommodate different types of STAs, including adjusting keep-alive time periods based on any corresponding power capability information transmitted to it.

Advantageously, embodiments allow the STAs with small battery capacity, such as, for example, a STA with a battery capacity roughly from about 200 mAh (such as a coin-cell battery) to about 3000 mAh (such as a Lithium AA battery) to inform their limitations and capabilities to the AP, so that the AP can treat them differently from other, less battery power constrained stations. As an example, one embodiment allows different classes of stations to use different Max Idle Period values. For example, according to an embodiment, STAs with very low duty cycles (such as STAs adapted to transmit a packet every few minutes to every tens of minutes) may have longer Max Idle Periods than STAs whose duty cycles do not fall within the given range. The stations with small battery capacity can ask for longer Max Idle periods than the other more capable or more active stations, and can thus sleep longer without being disconnected from the AP.

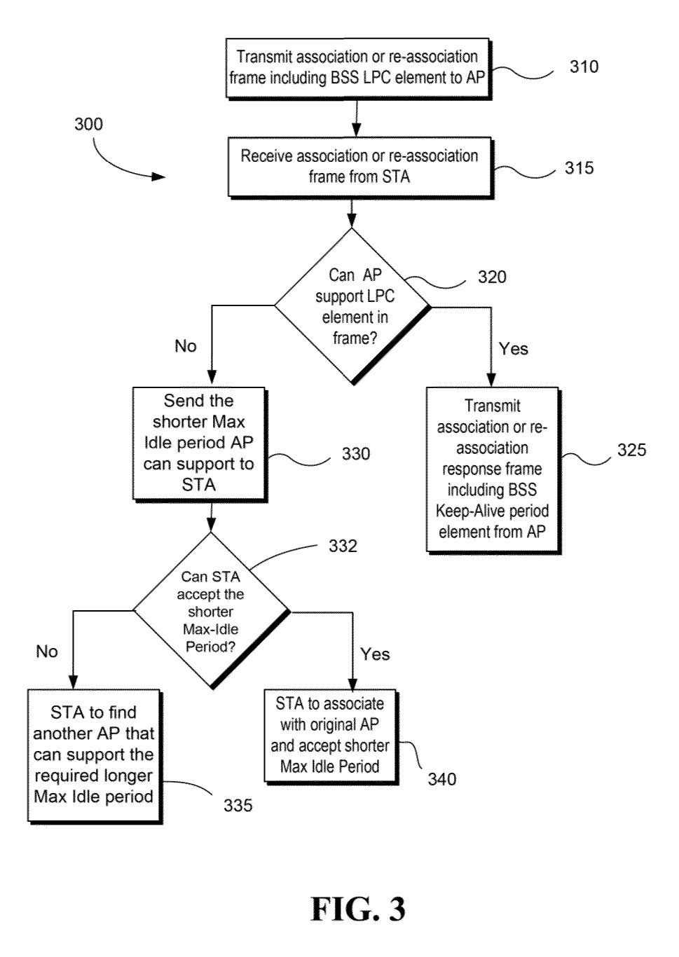

Referring now to FIG. 3, an exemplary schematic depiction is made in flowchart form of a method embodiment. In flow diagram 300, at 310 a STA may transmit an association or re-association frame including a BSS LPC element to an AP. As noted before the LPC element would include information regarding the power capabilities of the STA, such as for example, a Max Idle period, the power source for the STA (whether battery or line-power), the STA's battery capacity, etc. An AP may receive that frame at 315 and determine at 320 whether it can support the LPC element within the received frame. If the AP determines that it can support the LPC element within the received frame, the AP may at 325 transmit an association or re-association response frame to the STA in a BSS Max Idle period element. The Keep-Alive period may be equal to or greater than a Max Idle period communicated by the STA.

However, referring still to FIG. 3, if the AP determines that I cannot support the LPC element in the received frame, the AP may for example at 330 send the Max Idle period it can support to the STA. It is then up to the STA to decide what to do next, as indicated at block 332. If the STA really needs a longer Max Idle period than that can be supported by the AP, it may try at 335 to find another AP that can support the required longer Max Idle period. The STA may in the alternative at 340 just associate to the original AP and follow the shorter Max Idle period which the AP sent in the response frame, knowing that the STA will not have the expected battery life.

The foregoing description is intended to be illustrative and not limiting. Variations will occur to those of skill in the art. Those variations are intended to be included in the various embodiments of the invention, which are limited only by the scope of the following claims.

What is claimed is:

1. A device for communicating in a wireless network, the device comprising a processor, a memory, and a radio, wherein the device is to communicate to an associated access point (AP) information that includes a Max Idle time period corresponding to a time period set within the AP during which the device may be in a power save mode without being disconnected from the associated AP; and
wherein in the power save mode, the device is to selectively transmit to the associated AP and selectively refrain from transmission to the associated AP.

2. The device of claim 1, wherein the Max Idle Time period corresponds to a keep alive time period set within the associated AP and wherein the keep alive time period is a time period during which the device is to selectively transmit frames to the AP and selectively refrain from transmission of frames to the associated AP without being disassociated.

3. The device of claim 1, wherein the device is to communicate the information within an association or re-association frame.

4. The device of claim 1, wherein the device is to communicate the information as a parameter in a BSS Low Power Capability element.

5. The device of claim 4, wherein the associated AP is to further communicate the keep-alive time period to the device.

6. The device of claim 4, wherein the BSS Low Power Capability element is a portion of a BSS communication frame which is a portion of a block of a communication protocol within a BSS.

7. The device of claim 6, wherein a first field corresponds to an Element ID field and following the Element ID field is a Length field, which conveys information regarding a length of a Low Power Info field and wherein in the low power info field is the Max Idle time period.

8. A communication unit, comprising:
a wireless Radio Frequency (RF) transmitter to transmit wireless RF signals to an associated access point (AP), wherein the RF signals contain information that includes a Max Idle time period corresponding to a time period set within the associated AP during which the communication unit may be in a power save mode without being disconnected from the associated AP; and
wherein in the power save mode, the communication unit is to selectively transmit to the associated AP and selectively refrain from transmission to the associated AP.

9. A wireless station (STA), comprising:
a processor, a memory, and a radio, wherein the STA is to communicate to an associated access point (AP) information that includes a Max Idle time period corresponding to a time period set within the AP during which the STA may be in a power save mode without being disconnected from the associated AP; and
wherein in the power save mode, the STA is to selectively transmit to the associated AP and selectively refrain from transmission to the associated AP.

10. The STA of claim 9, further comprising a power controller configured to modify operational properties of the STA based on power-related algorithms or criteria.

11. The STA of claim 10, wherein the power controller is configured to turn off, turn on, enable, disable, connect or disconnect one or more components of the STA and is configured to command the STA or the components of the STA to go into a power-saving mode.

12. The STA of claim 11, wherein the radio comprises a wireless Radio Frequency (RF) transmitter configured to transmit wireless RF signals, blocks, frames, transmission streams, packets, messages or data through an antenna.

13. The STA of claim 11, wherein the radio comprises a wireless Radio Frequency (RF) receiver to wireless RF signals, blocks, frames, transmission streams, packets, messages or data through an antenna.

14. The STA of claim 13, wherein the antenna is an internal or external RF antenna, a dipole antenna, a monopole antenna, an omni-directional antenna, an end fed antenna, a circularly polarized antenna, a micro-strip antenna or a diversity antenna configured to transmit or receive wireless communication signals, blocks, frames, transmission streams, packets, messages and/or data.

15. The STA of claim 14, wherein some or all of the components of the STA are enclosed in a common housing or packaging, and are interconnected or operably associated using one or more wired or wireless links.

16. The STA of claim 14, wherein the components of the STA are distributed among multiple or separate devices or locations.

17. The STA of claim 9, wherein the STA is a communication station.

18. The STA of claim 9, wherein the STA is a mobile station.

19. The STA of claim 9, wherein the STA is an advanced station.

20. The STA of claim 9, wherein the STA is a client.

21. The STA of claim 9, wherein the STA is a platform.

22. The STA of claim 9, wherein the STA is a wireless communication device.

23. The STA of claim 9, wherein the STA is a modem.

24. The STA of claim 9, wherein the STA is a wireless modem.

25. The STA of claim 9, wherein the STA is a personal computer (PC).

26. The STA of claim 9, wherein the STA is a desktop computer.

27. The STA of claim 9, wherein the STA is a mobile computer.

28. The STA of claim 9, wherein the STA is a laptop computer.

29. The STA of claim 9, wherein the STA is a notebook computer.

30. The STA of claim 9, wherein the STA is a tablet computer.

31. The STA of claim 9, wherein the STA is a server computer.

32. The STA of claim 9, wherein the STA is a set-top box.

33. The STA of claim 9, wherein the STA is a handheld computer.

34. The STA of claim 9, wherein the STA is a handheld device.

35. The STA of claim 9, wherein the STA is a Personal Digital Assistant (PDA) device.

36. The STA of claim 9, wherein the STA is a handheld PDA device.

37. The STA of claim 9, wherein the STA is a netbook.

38. The STA of claim 9, wherein the STA is a sensor.

39. The STA of claim 9, wherein the STA is a camera.

40. The STA of claim 9, wherein the STA is a display.

41. The STA of claim 9, wherein the ISA is a headphone.

42. The STA of claim 9, wherein the STA is a smartphone.

43. An access point A operable in a wireless local area network, comprising:
a processor, a memory, and a radio, wherein the AP is to receive from a wireless station (STA) information that includes a Max Idle time period corresponding to a time period set within the AP during which the STA may be in a power save mode without being disconnected from the AP; and
wherein in the power save mode, the STA is to selectively transmit to the AP and selectively refrain from transmission to the AP.

44. The AP of claim 43, wherein the radio comprises a wireless Radio Frequency (RE) transmitter configured to transmit wireless RF signals, blocks, frames, transmission streams, packets, messages or data through an antenna.

45. The AP of claim 44, wherein the radio comprises a wireless Radio Frequency (RE) receiver to receive wireless RF signals, blocks, frames, transmission streams, packets, messages or data through an antenna.

46. The AP of claim 45, wherein the antenna is an internal or external RF antenna, a dipole antenna, a monopole antenna, an omni-directional antenna, an end fed antenna, a circularly polarized antenna, a micro-strip antenna or a diversity antenna configured to transmit or receive wireless communication signals, blocks, frames, transmission streams, packets, messages and/or data.

47. An article comprising a tangible computer-readable medium that contains instructions, which when executed by one or more processors result in performing operations comprising communicating information from a wireless station (STA) to an associated access point (AP), the information includes a Max Idle time period corresponding to a time period set within the AP during which the STA may be in a power save mode without being disconnected from the AP; and
wherein in the power save mode, the STA may refrain from transmitting to the AP.

48. The article of claim 47, wherein the Max Idle Time period corresponds to a keep alive time period set within the AP and wherein the keep alive time period is a time period during which the STA can refrain from transmitting frames to the associated AP without being disassociated.

49. The article of claim 47, wherein the STA is to communicate the information within an association or re-association frame.

50. The article of claim 47, wherein the device is to communicate the information as a parameter in a BSS Low Power Capability element.

51. The article of claim 50, wherein the access point is to further communicate the keep-alive time period to the device.

52. The article of claim 50, wherein the BSS Low Power Capability element is a portion of a BSS communication frame which is a portion of a block of a communication protocol within a BSS.

53. The article of claim 52, wherein a first field corresponds to an Element ID field and following the Element ID field is a Length field, which conveys information regarding a length of a Low Power Info field and wherein in the low power info field is the Max Idle time period.

54. A method, comprising:
communicating information from a wireless station (STA) to an associated access point (AP) that includes a Max Idle time period corresponding to a time period set within the AP during which the STA may be in a power save mode without being disconnected from the AP; and
wherein in the power save mode, the STA may refrain from transmitting to the AP.

55. The method of claim 54, wherein the Max Idle Time period corresponds to a keep alive time period set within the AP and wherein the keep alive time period is a time period during which the STA can refrain from transmitting frames to the associated AP without being disassociated.

56. The method of claim 54, wherein the STA is to communicate the information within an association or re-association frame.

57. The method of claim 56, wherein the device is to communicate the information as a parameter in a BSS Low Power Capability element.

58. The method of claim 57, wherein the access point is to further communicate the keep-alive time period to the device.

59. The method of claim 57, wherein the BSS Low Power Capability element is a portion of a BSS communication frame which is a portion of a block of a communication protocol within a BSS.

60. The method of claim 56, wherein a first field corresponds to an Element ID field and following the Element ID field is a Length field, which conveys information regarding a length of a Low Power Info field and wherein in the low power info field is the Max Idle time period.

61. A wireless station (STA), comprising:
a means for maintaining association between the wireless station (STA) and an associated access point (AP) while the STA is refraining from transmitting to the AP, the means comprising communicating a Max Idle time period from the STA to the AP corresponding to a time period set within the AP during which the STA may be in a power save mode without being disconnected from the AP; and
wherein in the power save mode, the STA is to selectively transmit to the associated AP and selectively refrain from transmission to the associated AP.

62. A wireless device, comprising:
a means for communicating a Max Idle time period from the wireless device to an associated AP corresponding to a time period to be set within the AP during which the STA may be in a power save mode without being disconnected from the AR; and
wherein in the power save mode, the wireless device is to selectively transmit to the associated AP and selectively refrain from transmission to the associated AP.

63. A system for communicating in a wireless network, comprising:
a wireless station (STA) including a processor, a memory, and a radio;
an access point (AP) associated with the STA; and
wherein the STA is configured to communicate to the associated AP information that includes a Max Idle time period corresponding to a time period to be set within the AP during which the device may be in a power save mode without being disconnected from the AP; and
wherein in the power save mode, the STA is to selectively transmit to the associated AP and selectively refrain from transmission to the associated AP.

64. The system of claim 63, wherein the Max Idle Time period corresponds to a keep alive time period set within the AP and wherein the keep alive time period is a time period during which the STA is to selectively transmit to the associated AP and selectively refrain from transmission to the associated AP without being disassociated with the associated AP.

65. The system of claim 63, wherein the STA is to communicate the information within an association or re-association frame.

66. The system of claim 63, wherein the device is to communicate the information as a parameter in a BSS Low Power Capability element.

67. The system of claim 64, wherein the access point is to further communicate the keep-alive time period to the device.

68. The system of claim 66, wherein the BSS Low Power Capability element is a portion of a BSS communication frame which is a portion of a block of a communication protocol within a BSS.

69. The system of claim 68, wherein a first field corresponds to an Element ID field and following the Element ID field is a Length field, which conveys information regarding a length of a Low Power Info field and wherein in the low power info field is the Max Idle time period.

70. A wireless station (STA) for communicating in a basic service set (BSS) in a wireless local area network (WLAN), the device comprising a processor, a memory, and a radio, wherein the device is to communicate to an associated access point (AP) information that includes a parameter BSSMaxIdlePeriod which indicates a time period during which the device is to selectively transmit to the associated AP and selectively refrain from transmission to the associated AP without being disassociated.

71. The STA of claim 70, wherein the Max Idle period corresponds to a keep alive time period set within the AP.

72. A sensor operable in a wireless local area network (WLAN), comprising:
a processor, a memory, and a radio, wherein the sensor is to communicate to an associated access point (AP) information that includes a Max Idle time period corresponding to a time period to be set within the AP during which the sensor may be in a power save mode without being disconnected from the AP; and
wherein in the power save mode, the device is to selectively transmit to the associated AP and selectively refrain from transmission to the associated AP.

73. The sensor of claim 72, further comprising a power controller configured to modify operational properties of the sensor based on power-related algorithms such that the power controller is capable of turning off, turning on, enabling, disabling, connecting or disconnecting one or more components of the sensor thereby putting the sensor into a power-saving mode.

74. The sensor of claim 73, wherein the WLAN operates conforming to one or more of an Institute for Electronic and electrical engineers (IEEE) 802.11, 802.11a, 802.11b, 802.11e, 802.11g, 802.11h, 802.11i, 802.11n, 802.11ac, 802.11ah standards.
